(19) United States
(12) Patent Application Publication
(10) Pub. No.: US 2024/0053456 A1
(43) Pub. Date: Feb. 15, 2024

(54) WORKING MACHINE WITH SENSOR MAINTENANCE SYSTEM

(71) Applicant: Kubota Corporation, Osaka (JP)

(72) Inventor: Kyle A. MARTIN, Tempe, AZ (US)

(73) Assignee: Kubota Corporation, Osaka (JP)

(21) Appl. No.: 18/449,631

(22) Filed: Aug. 14, 2023

Related U.S. Application Data
(60) Provisional application No. 63/398,174, filed on Aug. 15, 2022.

(51) Int. Cl. G01S 7/497; G01S 7/481; H04N 23/81; H04N 23/51

(52) U.S. Cl. CPC G01S 7/497; G01S 7/4813; H04N 23/811; H04N 23/51; G01S 2007/4977

(57) ABSTRACT

Some embodiments may include at least one sensor to collect at least a portion of data driving a perception system of a working machine or driving autonomously or semi-autonomously control of actuators of the working machine; a housing defining an environmentally isolated cavity containing the at least one sensor, the housing comprising: a signal-permeable material having an interior surface and an exterior surface, the interior surface defining part of the environmentally isolated cavity; and a body to passively divert water and/or debris away from the exterior surface of the signal-permeable material, at least part the exterior surface of the signal-permeable material inset with respect to a part of the body; and one or more devices to actively generate a barrier over part of the exterior surface of the signal-permeable material, wherein the actively generated barrier repeals particulate from at least part of the exterior surface of the signal-permeable material. Other embodiments may be disclosed and/or claimed.

### PRIORITY

This application is a non-provisional of U.S. Provisional Application No. 63/398,174 filed on Aug. 15, 2022, which is incorporated by reference herein.

### TECHNICAL FIELD

The present disclosure relates to off-highway working vehicles and other working machines, and some embodiments relate to a working machine with a sensor cleaning system.

### BACKGROUND

Off-highway working vehicles or other working machines, which may operate on steep or uneven ground, may include utility vehicles, such as tractors, lawnmowers, construction vehicles, agriculture vehicles, or the like. These working machines may have transportation systems, such as wheels, treads, walking devices, crawlers, or the like, to transport the working machine from one location to another. A motorized transportation system may be powered by any power source, such as a combustion engine, an electric motor, or the like, or combinations thereof.

In addition to the transportation system, these working machines may include tools for performing a work task, such as a residential operation, commercial operation, or industrial operation. Example work tasks may include mowing, spraying, harvesting, planting, digging, mining, leveling, or the like. These tools may also be referred to as implements, and may include:
Passive implements such as a plow that is pulled by a tractor, a trailer with a non-motorized transportation system, or the like; and
Motorized implements, such as a powered hitch to position a plow, a mower, a digger, a lawn edger, or the like.

Various components of these working machines (e.g., motorized devices of the transportation system and/or a motorized implement), may be configured to operate autonomously (e.g., fully autonomously or semi-autonomously). A robotic lawn mower is one example of a working machine that may operate fully autonomously. A tractor having an auto-steering system interfacing with the steering wheel (or steering wheel column) is one example of a semi-autonomous working vehicle (because an operator may manually steer the vehicle using the steering wheel).

### BRIEF DESCRIPTION OF THE DRAWINGS

FIG. 1 is a side view of a sensor assembly including a sensor maintenance system, according to various embodiments.

FIG. 2 is an isometric view of the sensor assembly of FIG. 1.

FIG. 3 is a schematic view of a body having a channel to direct a fluid away from an exterior surface of a signal-permeable material, according to various embodiments.

FIG. 4 is a schematic view of a working machine including the sensor assembly of FIG. 1, according to various embodiments.

FIG. 5 is a flow chart illustrating operations that may be performed by a controller of a working machine to operate any sensor assembly described herein, in various embodiments.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items. The systems, apparatus, and methods described herein should not be construed as limiting in any way. Instead, the present disclosure is directed toward all novel and non-obvious features and aspects of the various disclosed embodiments, alone and in various combinations and sub-combinations with one another. The term “or” refers to “and/or,” not “exclusive or” (unless specifically indicated).

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation. Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus.

Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art. In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Examples are described with reference to directions indicated as “above,” “below,” “upper,” “lower,” and the like. These terms are used for convenient description, but do not imply any particular spatial orientation.

On-highway vehicles may have perception systems (e.g., obstacle perception systems, environment perception systems, etc.) to provide autonomous or semi-autonomous operations and/or to generate displays for an operator or to generate a map of the environment. For example, on-highway vehicle may include sensors such as cameras, Lidar, and the like, which may collect raw data to drive the perception systems. If these sensors become fouled by contaminants, the perception systems may not perform optimally, which may impact autonomous or semi-autonomous operations performed by the on-highway vehicle and/or generated displays or maps. Although sensor fouling of on-highway vehicle sensors is possible, exposure on a highway may involve a small quantity of debris having a narrow range of different characteristics such as type of particulate (e.g., exhaust particuluate, brake dust, contaminants from tire wear, etc.) and angle of incidence (typically a relative trajectory of particulate is a direction opposite a direction the on-highway vehicle is traveling).

In contrast to an on-highway environment, a working environment, in which a working machine operates, may expose the machine/vehicle sensors to a harsh conditions having a wide range of different characteristics. For example, the implement(s) of the working machines, such as mower blades, tillage tools, diggers, etc., may kick up and/or propel a wide variety and/or large volume of debris or other contaminants, which can affect the operation of various components of a working machine.

While debris or other contaminants cast off by the working machine's own implement(s) may have a somewhat narrow range characteristics (and therefore may be contained to a degree, such as how the underside of a mower captures most of the pieces of cut grass), the working machines may be located in close proximity to other working machines, vehicles, operators, etc., which may kick up or cast off their own debris or other containments. Debris or other contaminants from other types of working machines, tools, and operators, may be propelled toward sensors of the working machine from essentially any direction in a busy working environment.

Typically, working machines may be maintained at maintenance intervals, which may include cleaning (besides other tasks such as refilling fuel and other fluids, repairs, etc.) The longer the maintenance interval, the more uptime available for the machine to perform working tasks. Also, since some working machines may operate seasonally (e.g., a harvest season, mowing season, etc.), systems/components that can allow a maintenance interval greater than the on-season duration are particularly valuable (because then the maintenance tasks can be scheduled to occur between seasons, i.e. always during the off-season).

What is needed is a sensor maintenance system to prevent, defer, and/or amerliorate sensor degradation in working machines, especially where it allows a working machine to operate uninterrupted through a working season. Various embodiments described herein may include a sensor assembly having rugged enclosure that protects sensor(s) contained therein from harsh environments. In some embodiments, the sensor assembly may have a sensor maintenance system including components to passively and/or actively reduce, prevent, and/or ameliorate contaminate build up, which may enable longer maintenance intervals for sensor systems. Various embodiments may automatically detect a dirty exterior of the sensor assembly and may initiate a cleaning cycle, with no (or minimal downtime) for the working machine.

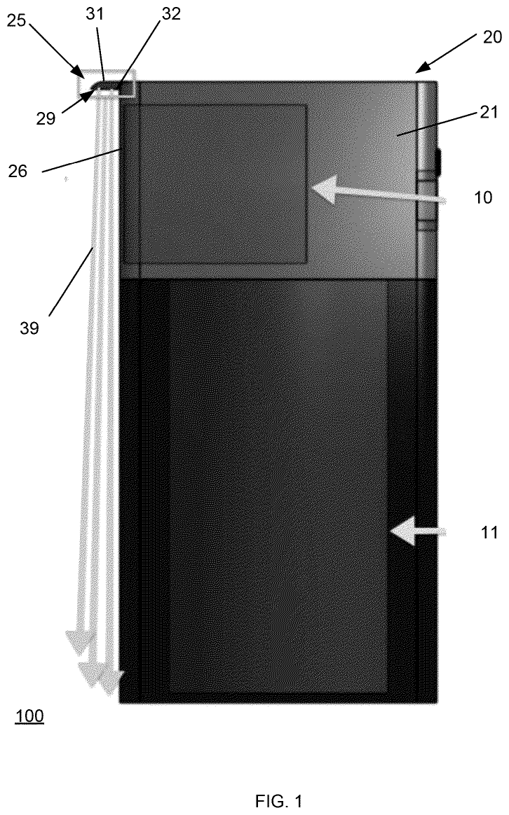

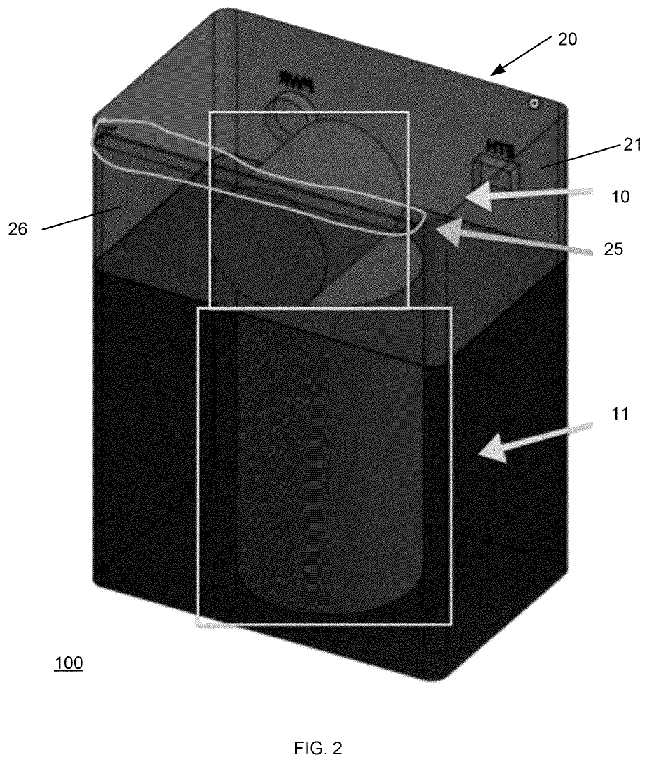

FIG. 1 is a side view of a sensor assembly 100 including a sensor maintenance system, according to various embodiments. FIG. 2 is an isometric view of the sensor assembly of FIG. 1. The sensor assembly 100 includes an enclosure 20 (such as a housing) defining an environmentally-isolated cavity 21 (e.g., a sealed chamber). Contained inside the cavity 21 are any number of sensors—in this example two sensors, e.g., a camera 10 and a LIDAR sensor 11.

A portion of one more sides of the enclosure 20 may be constructed from signal-permeable material(s). In an example where the enclosed sensor(s) include the camera 10, a light-permissive material (e.g., transparent plastic or some other transparent material) may pass external light into the cavity 21—where it is received by the camera 10. Light may be in various wavelengths—so the material used may be arranged to pass wavelength(s) detectable by the enclosed sensor(s). Although the signal is light in this example, other examples may use other types of sensors to collect other types signals, and the signal-permeable material may be chosen in order to pass the type of signals that the sensor(s) are arranged to collect.

The entire side of the enclosure 20 may be formed from the light-permissive material. However, this is not required. In some examples, one or more “windows” of the light-permissive material may be supported by some other material from which a remainder of that side is constructed. In an example with more than one window corresponding to more than one type of enclosed sensors, a side may have different signal-permeable materials used for different windows (based on a type of a corresponding sensor).

The sensor assembly 100 may passively and/or actively protect the exterior surface of the signal-permeable material 26 from the accumulation of contaminant thereon. Passive protection may be provided by include lips or other overhangs, channels or other liquid diverting structures, a treatment on the exterior surface, or the like, any of which may slow a build-up of particulates or other debris on the exterior surface. Active protection may include generated barriers (such as air barriers or electrostatic barriers), cleaning cycles, and the like, or combinations thereof. An interior surface of the signal-permeable material 26 may define part of the environmentally-isolated cavity 21, and therefore may not accumulate contaminants.

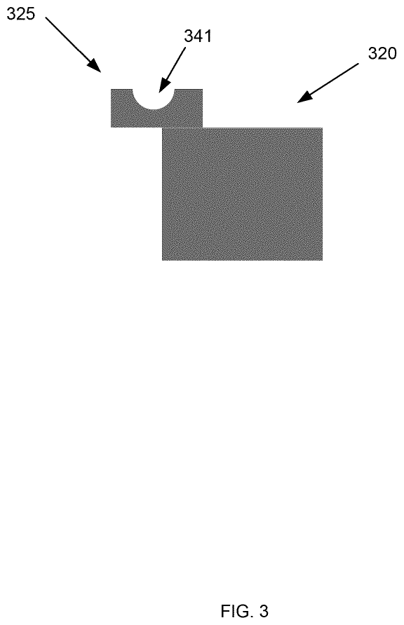

In this example, a sensor maintenance system of the sensor assembly 100 includes a body 25 coupled to, or integrally formed with the enclosure 20. A top side 31 of the body 25 provides passive protection in this embodiment. The top side 31 may be opposite the underside 32 that includes one or more devices 29 to generate the barrier 39. In this example, the body 25 is in the form of a lip 25, which may protect the exterior of the signal-permeable material 26 from raindrops, or any other liquid droplets (such as those from a sprayer of the working machine or a nearby working machine). FIG. 3 illustrates another example of an enclosure 320 having a lip 325. This lip 325 may have a top side, or some other side, including a channel 341 having an ingress to receive a liquid. An egress of the channel 341 may output the received liquid away from an exterior surface of a signal-permeable material of the enclosure 320.

Referring again to FIG. 1, any part of the enclosure 320 may include one or more devices 29 (located on the underside 32 of the body 25 or any other appropriate location) to generate a barrier 39 over the exterior surface of the signal-permeable material 26. In various embodiments, the barrier 39 may be continuously generated when the implement(s) and/or transportation systems are operating to prevent contaminants from reaching the exterior surface. In other embodiments, the barrier 39 may be generated only during certain predefined modes of operation (such as any time the predefined implement(s) are operating, but not in other cases such as when a motorized transportation system is driving the working machine from one working location to another). In yet other embodiments, the barrier 39 may be generated in response to sensing threshold environmental conditions and/or are based on location of the working machine. In yet other embodiments, the barrier 39 may be generated in response to a manual input by an operator of the working machine.

In this embodiment the barrier 39 is a fluid barrier (e.g., an air barrier), but in other embodiments the barrier 39 may be any other type of fluid (e.g., any other gas or liquid). The one or more devices 29 may include fluid ports arranged to propel air or some other fluid (e.g., a gas, a liquid, or combinations thereof) over the exterior of the signal-permeable material, as illustrated. The sensor assembly 100 may include a fan, a pump, an air compressor, a louvre, or the like, or combinations thereof) to feed air or some other fluid to the fluid ports at times when the barrier 39 is needed (such as transportation system and/or implements powered). In embodiments where air or some other fluid is fed to the fluid ports under certain conditions, control circuitry may determine when to generate the barrier 39 and may feed the fluid to the fluid ports on at that time. This control circuitry may be part of the sensor assembly 100, or may be located externally from the sensor assembly 100.

The flow rate of the fluid exiting from the fluid ports may be variable, or constant (e.g., continuous flow having a constant magnitude). In embodiments where the flow rate is variable, the flow rate may be increased or decreased by a controller (e.g., the previously described control circuitry), which may select a flow rate based on a sensor input or predefined conditions (such as the implement(s) performing working tasks).

In other embodiments, the barrier 39 may be some other type of generated barrier such as an electrostatic barrier. In these embodiments, the one or more devices 29 may include electrodes, or electrodes may be provided at any other location on the sensor assembly 100 necessary to create an electrostatic barrier over the signal-permeable material 26. An electrostatic barrier may repeal contaminants on a relative trajectory toward the signal-permeable material 26.

In various embodiments, another active system to prevent the build-up of contaminants on the signal-permeable material 26 may include a cleaning system. The cleaning system may spray a solvent or some other fluid onto the external surface of the signal-permeable material 26. In some embodiments, the cleaning system may propel the solvent or other fluid out of the same fluid ports 29, or out of some other fluid ports (not shown). In some embodiments, the cleaning system may utilize the same fluid as the barrier 39 (e.g., air), which may be propelled more forcefully and/or at different angles during a cleaning cycle. The barrier 39 may be briefly discontinued by control circuitry so that the barrier 39 does not redirect the fluid of the cleaning cycle, but may be resumed once the cleaning cycle is completed. In various embodiments, the cleaning cycle may be autonomously initiated or initialed by a manual input from an operator.

In one embodiments, the devices 29 may be pivotable—the control circuitry may, during the cleaning cycle, pivot one or more of the devices 29 from the default position illustrated in FIGS. 1-2 (to locate the barrier 39 as illustrated) to aim them at the signal-permeable material 26 and/or a detected build-up of contaminants on the signal-permeable material 26 in order to dislodge the build-up. In other embodiments, the devices 29 may include a dedicated fluid port for the cleaning cycle, which may be in a fixed position that is different than the other device(s) 29, or pivotable.

In various embodiments, a working machine may have more than one sensor to collect data to drive the perception system. In these embodiments, different parts of the signal-permeable material 26 may be cleaned in stages—in which the working machine may rely on sensors non-coinciding with the part of the signal-permeable material 26 being cleaned for a duration of that stage of the cleaning cycle. In this way, a cleaning cycle can be performed without downtime.

In various embodiments, any detected build-up of contaminants may be detected by one or more of the sensors located in the enclosure. For example, the camera 10 may generate images in which a location and degree of contaminant build-up may be detectable by controller circuitry analyzing the camera output. This information may be used to drive operations of the control circuitry. In other embodiments, the sensor assembly 100 may include a dedicated sensor inside or outside the sensor assembly to identify a degree and/or location of a contaminant build-up on the signal-permeable material 26. In another embodiment any other sensor of the working machine may be used to detect a degree and/or location build-up.

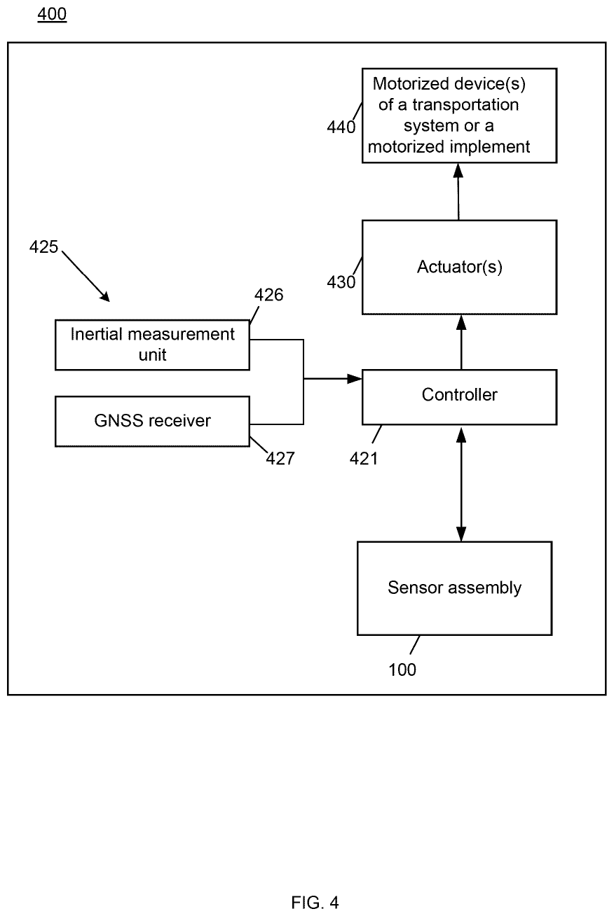

FIG. 4 is a schematic view of a working machine 400 including the sensor assembly 100 of FIG. 1, according to various embodiments. The working machine 400 may include one or more motorized devices 440, which may be components of a motorized transportation system or the working machine and/or a motorized implement(s) of the working machine. Actuator(s) 430 may drive movement of the motorized devices 440, under control of a controller 321. These motorized device(s) 440 and actuator(s) 430 may include any motorized devices of motorized transportation systems or motorized implements, now known or later developed.

The controller 421 may include a set of one or more processors, which may be implemented using any circuitry now known or later developed. Examples of circuitry that may be used to implement the set of one or more processors may include logic, application-specific processors, general purpose processors to execute instructions stored in a memory, or the like, or combinations thereof.

In some embodiments, the actuators 430 may be part of an auto-steering system similar to the auto-steering system described in U.S. Pat. No. 10,822,017 (which is herein incorporated by reference herein), or any other auto-steering system now known or later developed. In some embodiments, the set of one or more processors of the controller 421 may perform any functions of any precision guidance system (PGS) described in U.S. Pat. No. 10,986,767 (which is incorporated by reference herein), such as any of the steering controller functions and/or the processor functions described in that US patent.

In various embodiments, the sensor assembly 100 may include some of the sensors of the working machine 400 (e.g., camera 10 and Lidar 11 of FIG. 1), which may feed collected data, and/or data derived therefrom, to the controller 421. Other sensors 425 of the working machine 400 may be external from the sensor assembly 100, such as a location determining system for determining a current location of the working machine 400, and may also output collected data, and/or data derived therefrom, to the controller 421. In the illustrated embodiment, the location determining system may include sensors such as inertial measurement unit 426 and a Global Navigation Satellite System (GNSS) receiver 427, but in other embodiments a location determining system may include any other local or remote sensor, or other device, now known or later developed, for collecting raw information from which a current location of the working machine 400 may be derived.

Any controller/control circuitry operations described herein may be performed by a processor of a set of one or more processors of the controller 421. In some embodiments, a working machine may include a plurality of processors, one of which may control the actuator(s) 430 and another of which may perform any controller/control circuitry operations described herein. In these embodiments, the controller 421 may output a control signal to the sensor assembly 100 to turn a fluid source on or off, to pivot a fluid port for a cleaning cycle, or the like, or combinations thereof. In other embodiments, the sensor assembly 100 may include a dedicated controller that performs any controller/control circuitry operations described herein.

In various embodiments, the controller 421 may include a perception system to generate a display for an operator of the working machine or map an environment based data collected by the sensors 425 and sensors of the sensor assembly 100. In various embodiments, the motorized devices 440 of the transportation system or the one or more implements may be driven by actuators 430 controlled autonomously or semi-autonomously by the controller 421, based on the collected data from sensors 425 and sensors of the sensor assembly 100, to perform the one or more work tasks.

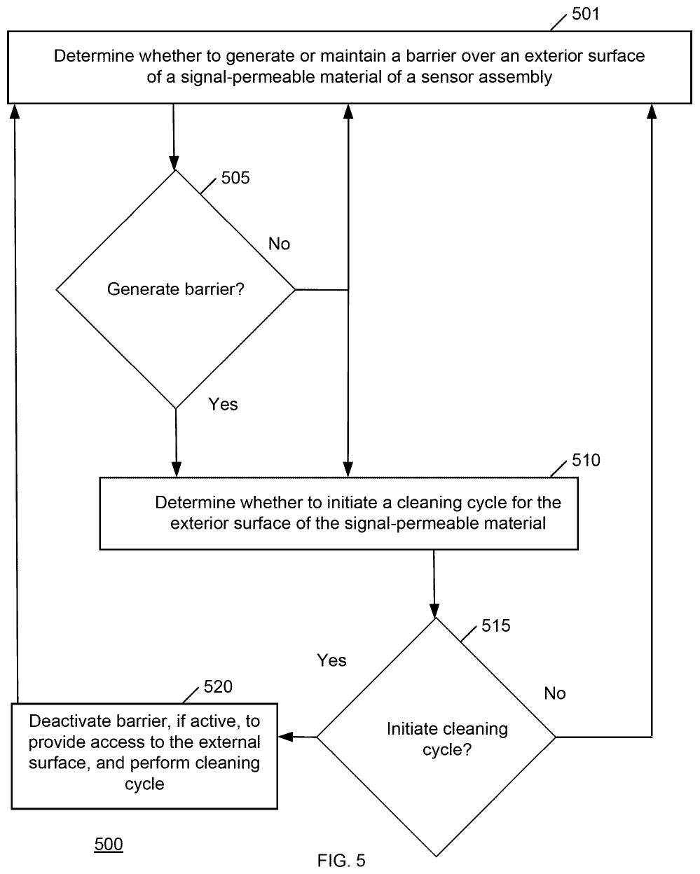

FIG. 5 is a flow chart illustrating operations 500 that may be performed by a controller of a working machine to operate any sensor assembly described herein, in various embodiments. In other embodiments, a process usable with any sensor assembly described herein may include only some of the operations 500.

In block 501, the controller may determine whether to generate or maintain a barrier over an exterior surface of a signal-permeable material of a sensor assembly. In diamond 505, the controller may generate the barrier or return to the operation of block 501.

In block 510, the controller may determine whether to initiate a cleaning cycle of the exterior surface of the signal-permeable material of the sensor assembly. In some embodiments, a barrier may need to be temporarily deactivated to access the exterior surface of the signal-permeable material for the cleaning cycle. In these embodiments, if a determination is made to initiate the cleaning cycle in diamond 515, in block 520 the controller may deactivate the barrier, if active, to provide access to the exterior surface of the signal-permeable material of the sensor assembly.

In block 520, the controller may initiate the cleaning cycle, in which a fluid, such as a solvent, air of an air pulse, or the like, or combinations thereof, may be applied to the exterior surface of the signal-permeable material of the sensor assembly. In some embodiments in which the barrier is a fluid barrier, a same fluid port may be used for the cleaning cycle. In these or other embodiments, initiating the cleaning cycle may include moving the fluid port (e.g., pivoting the fluid port) to a default cleaning position or to a position based on sensing a fouled part of the exterior surface of the signal-permeable material of the sensor assembly.

In view of the many possible embodiments to which the principles of the disclosed technology may be applied, it should be recognized that the illustrated embodiments are only preferred examples and should not be taken as limiting the scope of the disclosure.

1. An apparatus comprising:
a working machine to perform one or more work tasks, wherein the working machine includes a transportation system and one or more implements to perform the one or more work tasks;
wherein the working machine includes a perception system to generate a display for an operator of the working machine or map an environment based data collected by one or more sensors on the working machine, or wherein motorized components of the transportation system or the one or more implements are driven by actuators controlled autonomously or semi-autonomously, based on the collected data, to perform the one or more work tasks;
a sensor assembly having a housing defining an environmentally isolated cavity with at least one of the one or more sensors contained therein, the sensor assembly further including:
a signal-permeable material having an interior surface and an exterior surface, the interior surface defining part of the environmentally isolated cavity; and
a body to passively divert the water and/or debris away from the exterior surface of the signal-permeable material, at least part the exterior surface of the signal-permeable material inset with respect to a part of the body;
one or more devices to generate a barrier over part of the exterior surface of the signal-permeable material, wherein the actively generated barrier repeals particulate from at least part of the exterior surface of the signal-permeable material.

2. The apparatus of claim 1, wherein the body comprises an overhanging lip above the exterior surface of the signal-permeable material, wherein a top of the overhanging lip diverts the water and/or debris, and wherein the one or more devices include one or more fluid output ports located on an underside of the overhanging lip.

3. The apparatus of claim 1, wherein the body defines a channel having an ingress to receive the water and/or debris and an egress to release the water and/or debris away from the exterior surface of the signal-permeable material.

4. The apparatus of claim 1, wherein the actively generated barrier comprises an gas barrier and the one or more devices include one or more fluid ports to output gas of the gas barrier.

5. The apparatus of claim 1, wherein the actively generated barrier comprises an electrostatic barrier and the one or more devices include one or more electrodes to generate the electrostatic static barrier.

6. The apparatus of claim 1, wherein a first side of the body passively diverts the water and/or debris away from the exterior surface of the signal-permeable material, wherein the body comprises a second different side including one or more cleaning ports to output a solvent or other fluid on the exterior surface of the signal-permeable material during a cleaning cycle.

7. The apparatus of claim 6, further comprising circuitry to detect signal degradation of a signal collected by the at least one sensor and initiate the cleaning cycle in response to the detected signal degradation.

8. The apparatus of claim 6, further comprising circuitry to detect one or more characteristics of contaminant attached to the exterior surface of the signal-permeable material, wherein the cleaning cycle is based on the one or more detected characteristics.

9. The apparatus of claim 8, wherein the at least one sensor located in the cavity is used to detect the one or more characteristics of the attached debris.

10. The apparatus of claim 8, wherein the one or more sensors include at least one sensor located outside the cavity, wherein the at least one sensor located outside the cavity is used to detect the one or more characteristics of the attached contaminant.

11. A sensor assembly for a working machine, the sensor assembly comprising:
at least one sensor to collect at least a portion of data driving a perception system of the working machine or driving autonomously or semi-autonomously control of actuators of the working machine;
a housing defining an environmentally isolated cavity containing the at least one sensor, the housing comprising:
a signal-permeable material having an interior surface and an exterior surface, the interior surface defining part of the environmentally isolated cavity;
a body to passively divert water and/or debris away from the exterior surface of the signal-permeable material, at least part the exterior surface of the signal-permeable material inset with respect to a part of the body; and
one or more devices to actively generate a barrier over part of the exterior surface of the signal-permeable material, wherein the actively generated barrier repeals particulate from at least part of the exterior surface of the signal-permeable material.

12. The sensor assembly of claim 11, wherein the actively generated barrier comprises an gas barrier and the one or more devices comprises one or more fluid ports to output gas of the gas barrier.

13. The sensor assembly of claim 11, wherein the actively generated barrier comprises an electrostatic barrier and the one or more devices comprise one or more electrodes to generate the electrostatic static barrier.

14. The sensor assembly of claim 11, wherein a first side of the body passively diverts the water and/or debris away from the exterior surface of the signal-permeable material, wherein the body further includes a second different side having one or more cleaning ports to output a solvent or other fluid on the exterior surface of the signal-permeable material during a cleaning cycle.

15. The sensor assembly of claim 14, further comprising circuitry to detect signal degradation of a signal collected by the at least one sensor and initiate the cleaning cycle in response to the detected signal degradation.
